(19) United States
(12) Patent Application Publication
(10) Pub. No.: US 2019/0018558 A1
(43) Pub. Date: Jan. 17, 2019

(54) Sharing Method of Maintaining Multimedia Information Real-time Display on an Intelligent Terminal

(71) Applicant: Maoxiao PENG, Rui'an City (CN)

(72) Inventor: Maoxiao PENG, Rui'an City (CN)

(21) Appl. No.: 16/007,258

(22) Filed: Jun. 13, 2018

(30) Foreign Application Priority Data
Jul. 13, 2017 (CN) 201710570794.9

(51) Int. Cl. G06F 3/0484; G06F 3/0486; H04L 29/06; G06F 9/451

(52) U.S. Cl. CPC G06F 3/0484; G06F 9/451; H04L 65/60; G06F 3/0486

(57) ABSTRACT

A sharing method for maintaining real-time display of multi-media information on an intelligent terminal, to: extract interface multi-media information and encapsulating it, create floating widget which matches to the application program (APP) or the interface with the same data transmission protocol, and then forward and share the multimedia information of the interface. In that process, the multi-media information is continuously displayed, meanwhile automatic matching and forwarding under a data transmission protocol are realized, which improves convenience and efficiency of application sharing through the mobile terminal.

### FIELD

The invention belongs to the technical field of intelligent terminals, especially involving in a data transmission method that maintains real-time data display on intelligent terminal and the display interface will not be interrupted.

### BACKGROUND

As more and more users of mobile terminals, increase of users of intelligent mobile terminals, more and more users hope to share contents that they are interested at in the process of using. However, there are many drawbacks in data transmission mode in the process of sharing interface data through existing mobile terminals, especially when a video is shared. When users watch a local video, they want to share to circle of friends or some a friend, they need to pause the video, complete the sharing, and then return to the video. Therefore, it not only wastes a large amount of users' time in the process that users share data, but also has great influence to users' watching experience.

Furthermore, when a user is watching online liver broadcast, if he wants to share the live video information to friends, the user needs to interrupt the current display of the live video and then share the address of the live video to friends; however, when return to the live video after sharing, the live video directly jumps to the live content at the current time point, which results in missing of a lot of live content, cause that the user misses contents in the process, and the incoherent user experience is very bad.

In summary, the current technology has following problems: In the existing mobile terminal operating system, the video will not be shared when it is displayed in floating widget; therefore, in the information highly developed modern society, the operation of the video forwarding process is cumbersome and time-wasting; especially it cannot be paused in live video watching process, resulting in missing of live contents, which will seriously affect quick transmission of information and make users have bad experience and finally reduce use rate of the software.

### SUMMARY

The invention provides a sharing method for maintaining multi-media information real-time display on intelligent terminal to solve elaborate operation of current technology for users' sharing process so that users can realize information sharing quickly and conveniently; since it is time and effort saving and can be triggered by one key, users' experience is extremely simple and perfect.

In order to solve above problems, the invention discloses a sharing method for maintaining multimedia information real-time display on an intelligent terminal, specifically comprising:

A sharing method for maintaining multimedia information real-time display on an intelligent terminal, comprising:

Step 101: click the multimedia information data extraction button of the first application program (APP) or the first interface under the current interface of the intelligent terminal and encapsulate it;

Step 102:Transmit the encapsulated data packet to the custom controller for parsing, after the custom controller receives the encapsulated data packet, create a widget according to the encapsulated data packet with intelligent terminal system bottom view controller, and float the widget on the current interface to form a suspension widget;

Step 103: Match real-time displayed on the said floating widget to the second application program (APP) or a second interface with same data transmission protocol on the intelligent terminal interface.

Preferably, the step 103 specifically comprises the following steps: Click the transmission button on the floating widget to match the real-time data transmission displayed on the floating widget to the second application program (APP) or the second interface with the same data transmission protocol. During transmission and after transmission, the data in the floating widget is displayed in real-time. At the same time, the current application program or interface information data is also displayed in real time.

Preferably, Step 101 specifically comprises clicking the first application program (APP) or the multimedia information data extraction button of the first interface under the current interface of the intelligent terminal and encapsulating it as well as closing the 1st application program (APP) or the 1st interface of intelligent terminal; said step 103 specifically comprises opening the 2nd application program (APP) or the 2nd interface, simultaneously moving and floating the floating widget to the 2nd application program (APP) or the 2nd interface with same data transmission protocol, clicking transmission button on floating widget, and then transmitting and matching the data of floating widget to the 2nd application program (APP) or the 2nd interface with same data transmission protocol.

Preferably, said step 103 specifically comprises: drag the floating widget directly to the second application program (APP) or the second interface, and the floating widget automatically matches to interface of 2nd application program (APP) or the 2nd interface with same data transmission protocol, click transmission button on floating widget and transmit data to the 2nd application program (APP) or the 2nd interface that currently matches to same data transmission protocol.

Preferably, said step 103 specifically comprises: directly drag the floating widget to any direct application program (APP) or interface; while the widget will automatically match to interface with same data transmission protocol; the data can be transmitted to the 2nd application program (APP) or the 2nd interface that currently is matched to same data transmission protocol without clicking transmission button on floating widget.

Preferably, multimedia information data of said extracting intelligent terminal under interface comprises at least one of live broadcast, video, text, game, picture, and music.

Preferably, said transmitting the encapsulated data packet to the custom controller for parsing comprises transmitting the datagram to the custom controller through one of an interface definition language (AIDL), a broadcast, a messenger, and a URL Schema.

A sharing method for maintaining multimedia information real-time display on an intelligent terminal, comprising:

Step 201: click multi-media information data extracting button on the first application program (APP) or the first interface and create information data floating on the 1st application program (APP) or the 1st interface, while the floating widget and the 1st application program or the 1st interface maintain real-time data display;

Step 202: upload the created multimedia information data to the file server and acquire the URL of the created multimedia information data;

Step 203: Click the interface linked to the second application program (APP) or the second interface on the first application program (APP) or the first interface to achieve following actions simultaneously:

Open the second application program (APP) or the second interface and create a floating widget thereof, close the first application program (APP) or the first interface and the first application program (APP) or a floating widow on the first interface, transmit the URL of multimedia information data on floating widget of the 1st application program (APP) or the 1st interface to said 2nd application program (APP) or the 2nd interface in means of URL Schema; while the 2nd application program (APP) or the 2nd interface creates multi-media information data for floating widget according to the 2nd application program or the 2nd interface and floating widget and 2nd application program (APP) or interface maintains real-time data display.

Wherein, interface for acquiring the second application program (APP) or the second interface with the same data transmission protocol that the floating widget needs to share is integrated with the SDK, and the SDK is responsible for receiving the URL of the multimedia information data;

Step 204: click transmission button on floating widget of the 2nd application program (APP) or the 2nd interface to share the multi-media information data to the 2nd application program (APP) or the 2nd interface; simultaneously, the floating widget and the 2nd application program (APP) or the 2nd interface maintain real-time data display.

Preferably, multimedia information data of said extracting intelligent terminal under interface comprises at least one of live broadcasts, video, texts, games, pictures, and music.

Preferably, real-time display for multimedia information data of the floating widget floating on the current user interface is maintained; meanwhile, the multimedia information data of the user current interface floating on the floating widget is also displayed in real time.

In the technical scheme of the embodiment of the invention, the multimedia information data of the interface is extracted and encapsulated, a floating widget is created according to the encapsulated data, the widget matches the application program (APP) or interface with the same data transmission protocol, and then forwards the multi-media information according to operation of users; while in the sharing process, the multi-media information of widget is continuously displayed and after sharing, users can watch the multi-media information uninterruptedly. In the process, the user can share the multimedia information without interrupting the multimedia information of the current interface, which improves convenience and efficiency for sharing multi-media information through mobile terminals. In particular, the address of the live video can be shared to friends without interruption of the live video when a user is watching online live video so that a lot of live contents will not be missed, and the user experience is greatly improved.

### BRIEF DESCRIPTION OF THE FIGURES

Upon reading the following detailed description of the preferred embodiments, various other advantages and benefits will become apparent to those of ordinary technicians of the field. The figures are for purposes of illustrating preferred embodiments only and are not intended to limit the invention. What's more, throughout the figures, same parts are denoted by same reference symbols. In the attached figures:

FIG. 1 is a flowchart of a sharing method for maintaining real-time display of multimedia information on an intelligent terminal according to an embodiment of the present application;

FIG. 2 is a schematic diagram of operation according to one embodiment of the application.

FIG. 3 is a flowchart of a sharing method for maintaining real-time display of multimedia information on an intelligent terminal according to another embodiment of the application.

### DETAILED DESCRIPTION

Exemplary embodiments of the disclosure will be described in more details by referring to attached figures. Although exemplary embodiments of the disclosure are shown in the figures, it should be understood that the disclosure may be embodied in various forms without being limited to the embodiments set forth herein. On the contrary, these embodiments are provided to enable a more thorough understanding of the disclosure and to fully convey the scope of the disclosure to those technicians of the field.

The terminology used herein is for describing specific embodiments only and is not intended to limit the application. The singular form of “one,” “said” and “the” as used in this application and attached claims is also intended to include a majority of forms unless it is clearly indicated in the context. It should also be understood that the terms “and/or” as used herein refer to and include any or all possible combinations of one or more associated listed items.

### Embodiment I

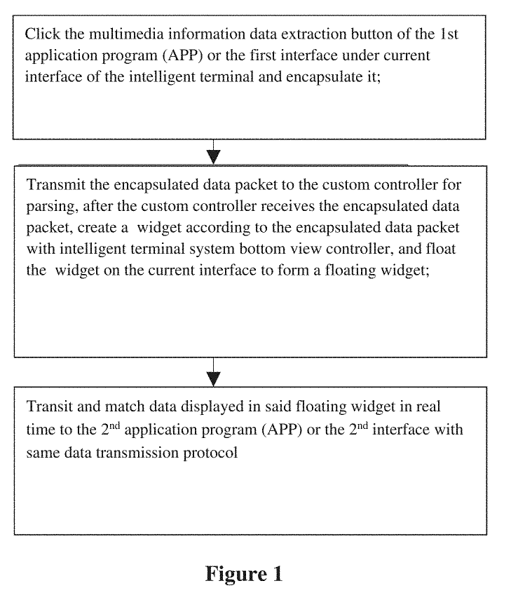

The invention discloses a sharing method for maintaining multimedia information real-time display on an intelligent terminal, as shown in FIG. 1, specifically comprising:

Step 101: Click the multimedia information data extraction button under the 1st application program or the 1st interface and encapsulate it.

Specifically, said step 101 further comprises: acquire an extraction rule matching the current web page, and extract a predetermined type of contents of the current web page with the extraction rule matching the current web page. After content of a predetermined type of the current web page is extracted with the extraction rule matching the current web page and the content of the current web page is extracted with the extraction rule matching the current web page, the extracted content of the predetermined type may also be encapsulated into a predetermined format.

Specifically, the first application program (APP) or the first interface under the current interface of the intelligent terminal includes but is not limited to various application programs or interfaces such as Wechat, micro-blog, and video playing terminal APP or interface. The multimedia information data comprises at least one of live broadcasts, videos, texts, games, pictures, and music.

Step 102: Transmit the encapsulated data packet to the custom controller for parsing, after the custom controller receives the encapsulated data packet, it creates a widget according to the encapsulated data packet with the intelligent terminal system bottom view controller, and float the widget on the current user interface;

Specifically, custom control parses the encapsulate data package, and acquires attribute information of the multimedia information data under the current interface of the intelligent terminal,

For example, if the current data is a video, attribute information such as type, name, and address of the video is acquired.

Then, the low-level view controller is called to create a video floating widget, and the video file is continuously played in the floating widget.

Specifically, in this embodiment, said method of creating the floating widget is: the creation widget is added to the main interface of the intelligent terminal through the bottom layer control manager.

Specifically, multimedia information data of the floating widget floating on the current user interface maintains real-time display, simultaneously multi-media information data displayed on application program or interface on user interface floated by floating widget also maintains real-time display.

Step 103: Match the data transmission displayed in real time in the floating widget to the second application (APP) or the second interface with same data transmission protocol on the intelligent terminal interface.

Specifically, floating widget automatically matches to the second application (APP) or the second interface with the same data transmission protocol on the user interface of the current intelligent terminal, click the transmission button on the widget, and then transmit data in the widget to the 2nd application program (APP) or the 2nd interface that is matched to same data transmission protocol;

Specifically, in the transmission process and after the transmission is completed, the multimedia information data in the floating widget is displayed in real time, and at the same time, the multimedia information data displayed by application program or interface information on user interface floated by floating widget is also displayed in real time.

Specifically, the first application program (APP) or the first interface under the current interface of the intelligent terminal includes, but is not limited to various application programs or interfaces such as Wechat, micro-blog, and video playing terminal APP.

Specifically, in this embodiment, one or more buttons may be set in the floating widget, the user may select the trigger area in the floating widget for operation, and different triggering modes correspond to different functions, for example, by clicking on the trigger area in the floating widget, under the condition, the floating widget expands several buttons in the form of a pull-down list for users to select.

Specifically, after a user clicks the button for inputting information on the widget, simultaneously information inputting box will be displayed; the user may input the recommendation information for the application in the information input box; text and expression may be input in the information input box, and the user may input the recommendation information for the application in the information input box. After inputting of the recommendation information is completed, the user may click the OK option to confirm the input completion of the recommendation information.

Specifically, after the user clicks the transfer button on the widget to acquire attribute information like the download address of the data in the encapsulated data package and the attribute information is sent to a receiver with the same data transmission protocol.

In a preferred embodiment, said step 101 specifically comprises: after clicking the 1st application program (APP) OR interface(open microblog with same data transmission protocol)the 1st application program (APP) or the 1st interface with same data transmission protocol on intelligent terminal interface, click the first application program (APP) or the multimedia information data extraction button of the first interface and encapsulate it and close the first application program (APP) or the first interface (close the micro-blog) of the intelligent terminal; said step 103 comprises: open the second application (app) or the second interface (open a Wechat with the same data transmission protocol) with the same data transmission protocol; simultaneously move and float the floating widget to the open second application program (app) or the second interface, the floating widget then automatically matches to the opened second application (APP) or second interface with the same data transmission protocol, click the transmission button on the floating widget, transmit the data on floating widget to the 2nd application program (APP) or interface that is matched to same data transmission protocol(the multimedia information in the floating widget extracted from the micro-blog is played while the data is transmitted from micro-blog to Wechat). Preferably, after the data transmission is completed, click the floating widget and the floating widget is enlarged to the normal widget (realizing that the user can continue to use the micro blog normally).

Preferably, after data transmission is completed, the floating widget remain floating, at the same time, use of 2nd application program (APP) or the 2nd interface is performed (that is use Wechat while watching video on floating widget of microblog).

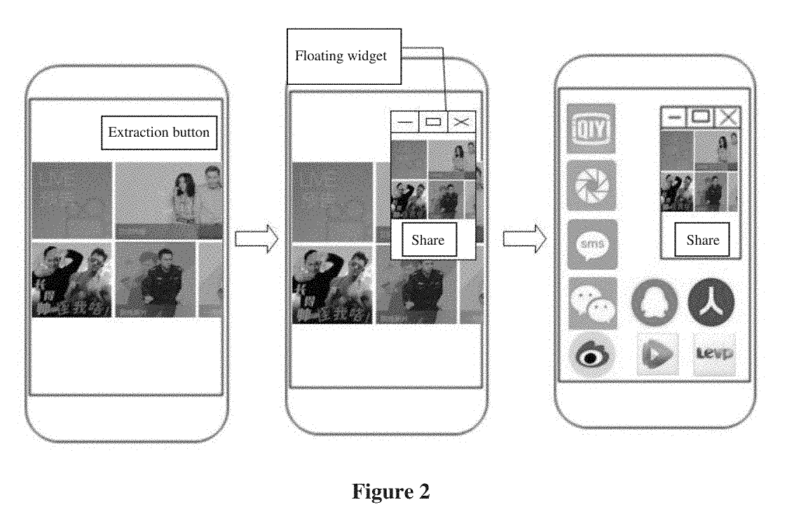

FIG. 2 specifically presents a schematic diagram of a method of extracting a floating widget and matching data of the floating widget to the second application (APP) or the second interface with the same data transmission protocol by clicking.

As shown in FIG. 2, a user clicks an extraction button on the current interface (first application program (APP) or first interface) of the intelligent terminal, to multimedia information data of the current interface of the intelligent terminal to the created floating widget, and displays in real time; at the same time, the contents of the current interface (the first application (APP) or the first interface) of the intelligent terminal are also displayed normally, and then the user clicks the sharing or transmission button on the floating widget to transmit data to the second application (APP) or the second interface that currently is matched the same data transfer protocol.

Specifically, the multimedia content presented in real time by the floating widget and the multimedia content presented in real time by the application program (APP) with the same data transmission protocol after sharing are displayed on the interface of the intelligent terminal simultaneously.

Specifically, as shown on the rightmost interface of FIG. 2, the second application (APP) or the second interface with the same data transmission protocol may be video software or social software with the same data transmission protocol, and the multimedia information is shared.

### Embodiment II

The invention discloses a sharing method for maintaining multimedia information real-time display on an intelligent terminal, as shown in FIG. 1, specifically comprising:

Step 101: Click the multimedia information data extraction button of the first application program (APP) or the first interface under the current interface of the intelligent terminal and encapsulate it;

Specifically, said step 101 further comprises: acquire an extraction rule matching the current web page, and extract a predetermined type of contents of the current web page with the extraction rule matching the current web page. After content of a predetermined type of the current web page is extracted with the extraction rule matching the current web page and the content of the current web page is extracted with the extraction rule matching the current web page, the extracted content of the predetermined type may also be encapsulated into a predetermined format.

Specifically, the multimedia information data of the current intelligent terminal user interface comprises at least one of live broadcasts, videos, texts, games, pictures, and music.

Step 102, after the encapsulated data packet is parsed, create a floating widget.

Specifically, the encapsulated data packet is transmitted to the custom controller for parsing, after the custom controller receives the encapsulated data packet, the intelligent terminal system bottom view controller is used to create a widget according to the encapsulated data packet, and the widget is floated on the current user interface;

Specifically, custom controller parses the encapsulate data package, and acquires attribute information of multimedia information data of the current intelligent terminal user interface,

For example, if the current data is a video, attribute information such as type, name, and address of the video is acquired.

Then, the low-level view controller is called to create a video floating widget, and the video file is continuously played in the floating widget.

Specifically, in this embodiment, said method for creating a floating widget is: create a widget and add it to the main interface of the mobile terminal through the underlying control manager.

Specifically, the multimedia information data of the floating widget floating on the current user interface maintains real-time display and the multimedia information data displayed by the application program or the interface information on the user interface floating on the floating widget also maintains real-time display.

Step 103, the real-time data transmission displayed in the floating widget is matched to the second application program (APP) or the second interface with the same data transmission protocol on the intelligent terminal interface.

Specifically, the floating widget automatically matches the second application (app) or the second interface with the same data transmission protocol on the current intelligent terminal user interface, drag the floating widget to transmit the data in the floating widget to the second application program (APP) or a second interface that matches to the same data transmission protocol;

Specifically, in the transmission process and after the transmission is completed, the multimedia information data in the floating widget is displayed in real time, and at the same time, the multimedia information data displayed by application program or interface information on user interface floated by floating widget also is also displayed in real time.

Specifically, the first application program (APP) or the first interface under the current interface of the intelligent terminal includes, but is not limited to various application programs or interfaces such as Wechat, micro-blog, and video playing terminal APP.

Specifically, in this embodiment, one or more buttons may be set in the floating widget, the user may select the trigger area in the floating widget for operation, and different triggering modes correspond to different functions, for example, by clicking on the trigger area in the floating widget, under the condition, the floating widget expands several buttons in the form of a pull-down list for users to select.

Specifically, after a user clicks the button for inputting information on the widget, simultaneously information inputting box will be displayed; the user may input the recommendation information for the application in the information input box; text and expression may be input in the information input box, and the user may input the recommendation information for the application in the information input box. After inputting of the recommendation information is completed, the user may click the OK option to confirm the input completion of the recommendation information.

Specifically, in step 103, directly drag the floating widget to the second application program (APP) or the 2nd interface, the floating widget automatically matches the second application (app) or an interface in the second interface with the same data transmission protocol, click the transmission button on the floating widget to transit the data to the receiver that currently is matched to the same data transfer protocol. Or in step 103, the floating widget is directly dragged and floated to any application program (APP) or interface, the widget automatically matches the interface with the same data transmission protocol in the current application program (APP) or interface and data can be transmitted to a receiver (that second application (APP) or second interface) that is currently matched to the same data transfer protocol without clicking the transmission button on the floating widget.

Specifically, after a user clicks the transmission button on the floating widget, attribute information like the download address of the data in the encapsulated data packet is acquired, and the attribute information is sent to a receiver with the same data transmission protocol.

In a preferred embodiment, said step 101 specifically comprise: after clicking the first application program (APP) or the first interface with the same data transmission protocol on the interface of the intelligent terminal (open the micro-blog with the same data transmission protocol), click said multi-media information data extraction button on the said the 1st application program (APP) or the 1st interface and encapsulate it, close the intelligent terminal first application (APP) or the first interface (close the micro-blog); step 103 specifically comprises: open the second application (app) or the second interface (open a Wechat with the same data transmission protocol) with the same data transmission protocol, simultaneously move and float the floating widget to the opened second application program (app) or the second interface, and then the floating widget automatically matches the opened second application (app) or second interface with the same data transmission protocol, drag the floating widget to a second application (APP) or second interface with the same data transfer protocol; data of the floating widget is transmitted to a the second application program (APP) or the second interface that is matched to the same data transmission protocol(multi-media information in the floating widget extracted from the micro blog is played while the micro-blog is forwarded to the Wechat).

Specifically, establish associated relationship between users and the group before users share information with other groups.

Specifically, the floating widget judges whether there are corresponding other group users associated with the current user in the second application (APP) or the second interface with the same data transmission protocol on the current interface of the intelligent terminal; if so, click the transmission button on the widget, and then forward the sharing page information to the associated other group users.

Specifically, automatically matching an application (APP) or interface with the same data transmission protocol on the current interface of the intelligent terminal comprises: The first application program (APP) or the first interface and the second application program (APP) or the second interface are both application programs (APP) or the interface that already have the same data transmission protocol; Or acquire a transmission protocol and a user identification code specific for floating widget communication module; while the transport protocol contains specific text content, commands, characters or character codes, etc.; further, the specific character encoding is determined in advance by the user and exists in the transmission protocol. The floating widget automatically scans the application program (APP) or the interface on the user interface in the current intelligent terminal, detect and test the transmission protocols of these application programs (APP) and the interface; If the two transmission protocols both contain a specific character code, it is indicated that the two are matched. After matching, a data transmission channel is established to share multimedia information.

### Embodiment III

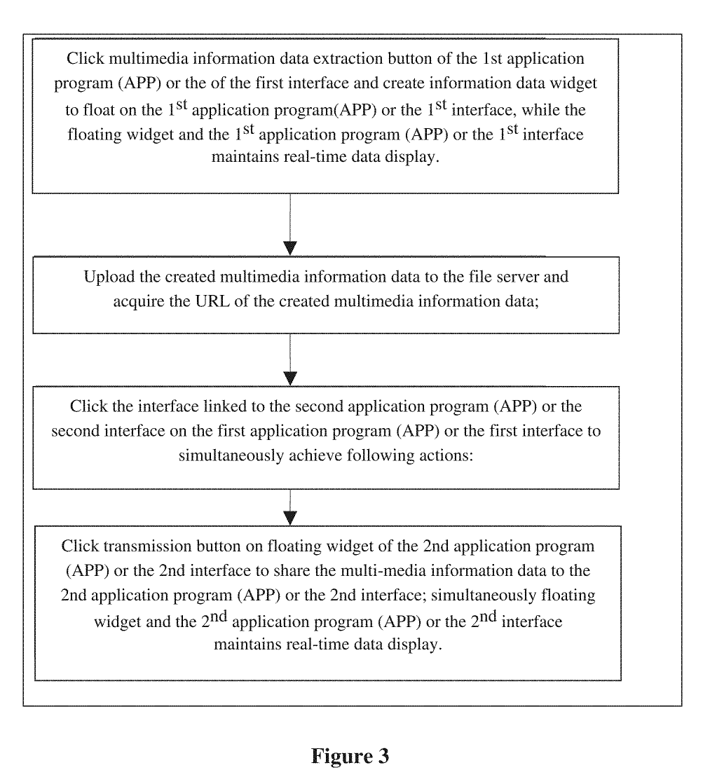

The invention discloses a sharing method for maintaining multimedia information real-time display on an intelligent terminal, as shown in FIG. 3, specifically comprising:

Step 201: click multi-media information data extracting button on the first application program (APP) or the first interface and create information data floating on the 1st application program (APP) or the 1st interface, while the floating widget and the 1st application program or the 1st interface maintain real-time data display;

Step 202: upload the created multimedia information data to the file server and acquire the URL of the created multimedia information data;

Step 203: Click interface linked to the second application program (APP) or the 2nd interface on the 1st application program (APP) or the 1st interface, and realize following actions simultaneously:

Open the second application (APP) or a second interface, and create a floating widget, close the first application program (APP) or the first interface and the floating widget of the first application program (APP) or the first interface; transmit a URL of the first application program (APP) or multimedia information data of a floating widget on a first interface to the second application program (APP) or the second interface through a URL Schema; the 2nd application program (APP) or the 2nd interface create multi-media information of floating widget according to said URL; floating widget and the 2nd application program (APP) or interface maintain real-time data display.

Wherein, interface for acquiring the second application program (APP) or the second interface with the same data transmission protocol that the floating widget needs to share is integrated with the SDK, and the SDK is responsible for receiving the URL of the multimedia information data;

Step 204: click transmission button on floating widget of the 2nd application program (APP) or the 2nd interface to share the multi-media information data to the 2nd application program (APP) or the 2nd interface; simultaneously, the floating widget and the 2nd application program (APP) or the 2nd interface maintain real-time data display.

Specifically, step 201 also comprises extracting multi-media information data of current intelligent terminal, including at least one of video, text, game, picture and music.

Specifically, step 204 further comprises maintaining real-time display of the multi-media information data of the floating widget floating on the current user interface, while the multimedia information data displayed by the application program or the interface information on the floating widget floating on the user interface maintains real-time display.

Above description is only a preferred embodiment of the invention, but the scope of the invention is not limited thereto, and any changes or alternatives that can be easily recollected by those skilled in the field within the scope of the disclosed technology should be covered in scope of the invention. Therefore, the protection scope of the invention shall be governed by the scope of protection of the claims.

1. A sharing method for maintaining real-time display of multimedia information on an intelligent terminal, comprising:
Step 101: click the multimedia information data extraction button of the 1st application program (APP) or the first interface under current interface of the intelligent terminal and encapsulate it;
Step 102: transmit the encapsulated data packet to the custom controller for parsing, after the custom controller receives the encapsulated data packet, create a widget according to the encapsulated data packet with intelligent terminal system bottom view controller, and float the widget on the current interface to form a floating widget;
Step 103: match data real-time displayed on the said floating widget to the second application program (APP) or the second interface with the same data transmission protocol on the intelligent terminal interface.

2. The method described in claim 1, said step 103 comprises: Click the transmission button on the floating widget to match the real-time data transmission displayed on the floating widget to the second application program (APP) or the second interface with the same data transmission protocol. During transmission and after transmission, the data in the floating widget is displayed in real-time. At the same time, the current application program or interface information data is also displayed in real time.

3. The method described in claim 2, the step 101 specifically comprises: after clicking on the first application program (APP) terminal or the first interface with the same data transmission protocol on the interface of the intelligent, click the multimedia information data extraction button of the first application program (APP) or the first interface and encapsulate it into a floating widget, and close the first application program (APP) or the first interface of the intelligent terminal; the second application (APP) or second interface moves and floats the widget to opened the second application program (APP) or the second interface, and then the floating widget automatically matches the opened second application (APP) or second interface with the same data transmission protocol, click the transmission button on the floating widget to transmit data in the floating widget to the second application program (APP) or the second interface that matches to same data transmission data protocol.

4. The method described in claim 1, the step 103 specifically comprises: drag the floating widget directly to the second application program (APP) or the second interface, the floating widget automatically matches the interfaces of the second application program (APP) or the second interface with the same data transmission protocol, click the transmission button on the floating widget to transmit and match the data to the second application (APP) or the second interface with same data transmission protocol.

5. The method described in claim 1, the step 103 specifically comprises: directly drag the floating widget to any direct application program (APP) or interface; while the widget will automatically match to interface with same data transmission protocol; the data can be transmitted to the 2nd application program (APP) or the 2nd interface that is currently matched to same data transmission protocol without clicking transmission button on floating widget.

6. The any method described in claim 1, the multimedia information data of said extracting intelligent terminal user interface comprises at least one of live broadcast, video, text, games pictures and music.

7. The any method described in claim 1, said transmitting the encapsulated data packet to the custom controller for parsing comprises transmitting the datagram to the custom controller through one of an interface definition language (AIDL), a broadcast, a messenger, and a URL Schema.

8. A sharing method for maintaining real-time display of multimedia information on an intelligent terminal, comprising:
Step 201: click multi-media information data extracting button on the first application program (APP) or the first interface and create information data floating on the 1st application program (APP) or the 1st interface, while the floating widget and the 1st application program or the 1st interface maintains real-time data display;
Step 202: upload the created multimedia information data to the file server and acquire the URL of the created multimedia information data;
Step 203: click the interface linked to the second application program (APP) or the second interface on the first application program (APP) or the first interface to achieve following actions simultaneously:
open the 2nd application program or the second interface and floating widget created at same time, close floating widget on the 1st application program (APP) or the 1st interface and the 1st application program or the 1st interface, transmit the URL of multi-media information data of the 1st application program or the 1st interface in means of URL Schema to the 2nd application program or the 2nd interface, the 2nd application program (APP) or the 2nd interface creates multi-media information data according to the stated URL, while floating widget and the 2nd application program (APP) or interface maintains real-time data display,
wherein, interface for acquiring the second application (APP) or the second interface with the same data transmission protocol which needs to be shared by the floating widget is integrated with the SDK and SDK is responsible for receiving a URL of multimedia information data;
Step 204: click transmission button on floating widget of the 2nd application program (APP) or the 2nd interface to share the multi-media information data to the 2nd application program (APP) or the 2nd interface; simultaneously, the floating widget and the 2nd application program (APP) or the 2nd interface maintain real-time data display.

9. The method described in claim 8, the multi-media information data of the stated intelligent terminal user interface comprises at least one of live broadcast, video, text, game, picture and music.

10. The method described in claim 1, multi-media information data of said floating widget floated at current user interface maintains real-time display, the multimedia information data on the user's current interface floated by the floating widget is also displayed in real time.

11. The method described in claim 8, multi-media information data of said floating widget floated at current user interface maintains real-time display, the multimedia information data on the user's current interface floated by the floating widget is also displayed in real time.
